(19) United States
(12) Patent Application Publication
(10) Pub. No.: US 2026/0353306 A1
(43) Pub. Date: Nov. 5, 2026

(54) POWER BOOST FOR DELAY CRITICAL PROCEDURES

(71) Applicant: QUALCOMM Incorporated, San Diego, CA (US)

(72) Inventors: Sitaramanjaneyulu KANAMARLAPUDI, San Diego, CA (US); Linhai HE, San Diego, CA (US)

(21) Appl. No.: 19/651,569

(22) Filed: Apr. 17, 2026

Related U.S. Application Data
(60) Provisional application No. 63/797,725, filed on Apr. 30, 2025.

(51) Int. Cl. H04W 52/26

(52) U.S. Cl. CPC H04W 52/26

(57) ABSTRACT

This disclosure provides methods, components, devices and systems for power boost for delay critical procedures. For example, wireless device (such as a user equipment (UE) or a network node) may communicate (e.g., receive or transmit) a power boost configuration that is applicable to delay-sensitive messaging during a delay remediation procedure, such as a delay status report (DSR) procedure. The delay-sensitive messaging may include a DSR medium access control-control element (MAC-CE) which triggers a scheduling request (SR), a MAC transport block (TB) included in a DSR MAC-CE to indicate buffer status information of delay-sensitive data, and/or a message that includes the delay-sensitive data. The power boost configuration may indicate power boost parameters, which may be indicated based on a logical channel group (LCG) of the delay-sensitive data, a power class of the wireless device, or a service type associated with the delay-sensitive data.

### CROSS REFERENCE

The present Application for Patent claims the benefit of U.S. Provisional Patent Application No. 63/797,725 by KANAMARLAPUDI et al., entitled “POWER BOOST FOR DELAY CRITICAL PROCEDURE,” filed Apr. 30, 2025, assigned to the assignee hereof, and expressly incorporated by reference herein.

### TECHNICAL FIELD

This disclosure relates generally to wireless communication, and more specifically to systems, devices, methods, and techniques associated with power boost for delay critical procedures.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network nodes (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a wireless device (such as a user equipment (UE) or a network node) is described. The method may include communicating an indication of a power boost configuration indicating one or more power boost parameters for boosting transmission power of delay-sensitive messaging when a delay remediation procedure is triggered, where the delay remediation procedure is triggered based on a remaining amount of time for communication of delay-sensitive data and communicating, in accordance with a transmit power level that is boosted in accordance with the one or more power boost parameters, a first message based on the delay remediation procedure being triggered.

A wireless device (such as a UE or a network node) for wireless communications is described. The wireless device may include a processing system that includes processor circuitry and memory circuitry that stores code. The processing system may be configured to cause the wireless device to communicate an indication of a power boost configuration indicating one or more power boost parameters for boosting transmission power of delay-sensitive messaging when a delay remediation procedure is triggered, where the delay remediation procedure is triggered based on a remaining amount of time for communication of delay-sensitive data and communicate, in accordance with a transmit power level that is boosted in accordance with the one or more power boost parameters, a first message based on the delay remediation procedure being triggered.

Another wireless device (such as a UE or a network entity) for wireless communications is described. The wireless device may include means for communicating an indication of a power boost configuration indicating one or more power boost parameters for boosting transmission power of delay-sensitive messaging when a delay remediation procedure is triggered, where the delay remediation procedure is triggered based on a remaining amount of time for communication of delay-sensitive data and means for communicating, in accordance with a transmit power level that is boosted in accordance with the one or more power boost parameters, a first message based on the delay remediation procedure being triggered.

A non-transitory computer-readable medium storing code for wireless communications is described. The code may include instructions executable by one or more processors to communicate an indication of a power boost configuration indicating one or more power boost parameters for boosting transmission power of delay-sensitive messaging when a delay remediation procedure is triggered, where the delay remediation procedure is triggered based on a remaining amount of time for communication of delay-sensitive data and communicate, in accordance with a transmit power level that is boosted in accordance with the one or more power boost parameters, a first message based on the delay remediation procedure being triggered.

Some examples of the method, wireless devices, and non-transitory computer-readable medium described herein may further include operations, features, means, or instructions for communicating an indication of a transmit power boost range based at least in part on the one or more power boost parameters, inputting, into an artificial intelligence (AI)-native machine learning model, one or more AI-native parameters corresponding to the delay-sensitive messaging, and obtaining a model inference from the AI-native machine learning model, the model inference comprising at least the transmit power level selected from the transmit power boost range.

In some examples of the method, wireless devices, and non-transitory computer-readable medium described herein, the model inference may be based on information obtained from a modem of the wireless device, a service in an application processor, a UE-based AI-native machine learning model, a network-based AI-native machine learning model, or any combination thereof.

In some examples of the method, wireless devices, and non-transitory computer-readable medium described herein, the one or more AI-native parameters are based in part on a packet block error rate (BLER) of the delay-sensitive messaging, a packet error rate (PER) of the delay-sensitive messaging, or both.

In some examples of the method, wireless devices, and non-transitory computer-readable medium described herein, communicating the first message may include operations, features, means, or instructions for communicating, in accordance with the transmit power level that may be based on the one or more power boost parameters, the first message including a medium access control-control element (MAC-CE) that provides a delay status report (DSR) corresponding to the delay-sensitive data.

In some examples of the method, wireless devices, and non-transitory computer-readable medium described herein, the MAC-CE includes a scheduling request (SR) that requests an uplink grant for transmission of the delay-sensitive data.

In some examples of the method, wireless devices, and non-transitory computer-readable medium described herein, the MAC-CE includes a transport block (TB) indicating the DSR.

In some examples of the method, wireless devices, and non-transitory computer-readable medium described herein, communicating the first message may include operations, features, means, or instructions for communicating, in accordance with the transmit power level that may be based on the one or more power boost parameters, a TB including the delay-sensitive data.

In some examples of the method, wireless devices, and non-transitory computer-readable medium described herein, the one or more power boost parameters include a first power boost parameter for a first logical channel group (LCG) and the transmit power level used to transmit the first message may be in accordance with the first power boost parameter for the first LCG.

In some examples of the method, wireless devices, and non-transitory computer-readable medium described herein, the one or more power boost parameters include a first power boost parameter for a first UE power class of a set of multiple UE power classes and the transmit power level used to transmit the first message may be in accordance with the first power boost parameter for the first UE power class.

In some examples of the method, wireless devices, and non-transitory computer-readable medium described herein, the one or more power boost parameters include a first power boost parameter for a first service type and the transmit power level used to transmit the first message may be in accordance with the first power boost parameter for the first service type.

Some examples of the method, wireless devices, and non-transitory computer-readable medium described herein may further include operations, features, means, or instructions for communicating capability information indicating a capability of the wireless device to support transmission power boosting of the delay-sensitive messaging.

In some examples of the method, wireless devices, and non-transitory computer-readable medium described herein, the one or more power boost parameters indicate a fixed transmit power boosting value or one or more transmit power boosting increments.

In some examples of the method, wireless devices, and non-transitory computer-readable medium described herein, the indication of the power boost configuration may be via control signaling, broadcast signaling, or both.

### BRIEF DESCRIPTION OF THE DRAWINGS

FIG. 1 shows an example of a wireless communication system.

FIG. 2 shows an example of a signaling configuration that supports power boost for delay critical procedures.

FIG. 3 shows an example of a process flow that supports power boost for delay critical procedures.

FIG. 4 shows a block diagram of a processing system that supports power boost for delay critical procedures.

FIG. 5 shows a diagram of a system including a device that supports power boost for delay critical procedures.

FIG. 6 shows a flowchart illustrating methods that support power boost for delay critical procedures.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, such as in XR applications, a user equipment (UE) may be configured to transmit data (e.g., protocol data units (PDUs)) according to relatively stringent timing constraints, to reduce latency and to enable an immersive experience for a user. Such data may be referred to herein as delay-sensitive data or delay critical data. The UE may be configured to perform a delay status report (DSR) procedure (e.g., or other delay remediation procedure) triggered by a remaining time for communication of the delay-sensitive data satisfying a configured threshold. During the DSR procedure, the UE may trigger scheduling requests (SRs) (e.g., if no grant has been given for transmission of the delay-sensitive data), may transmit DSRs including buffer status information for the delay-sensitive data, and/or may transmit the delay-sensitive data itself. However, the various delay-sensitive messaging which is communicated between the UE and a network (e.g., after the DSR procedure has been triggered) may lack reliability, which may result in increased latency and reduced throughput, among other performance degradations.

Aspects of the subject matter described in this disclosure relate to power boost for delay critical procedures. For example, a UE may receive a power boost configuration that is applicable to delay-sensitive messaging during a delay remediation procedure (e.g., DSR procedure). The delay remediation procedure may involve scheduling and sending messaging in an attempt to coordinate with a network entity in order to deliver the delay-sensitive messaging on time. The delay-sensitive messaging may include a DSR medium access control-control element (MAC-CE) which triggers a SR, a MAC transport block (TB) included in a DSR MAC-CE to indicate the buffer status information, and/or a message (e.g., TB) that includes the delay-sensitive data. The power boost configuration may indicate power boost parameters (e.g., an amount of power boosting or transmission power to use), which may be indicated based on a logical channel group (LCG) of the delay-sensitive data, a power class of the UE, or a service type associated with the delay-sensitive data.

Particular aspects of the subject matter described in this disclosure can be implemented to realize one or more of the following potential advantages. In some examples, by configuring power boosting to be used for one or more messages in a delay critical procedure, the described techniques can be used to increase a reliability of communication for the delay critical data, which may reduce latency and increase throughput. For example, by boosting the transmission power used to communicate such messages, the UE may ensure that the messages will be received and recognized by a network node, which may result in a more efficient scheduling, a faster and more efficient grant allocation for the UE to communicate the delay-sensitive data, an improved coordination between devices in the wireless communications system, and improved key performance indicator (KPI) performance leading to enhanced user experience.

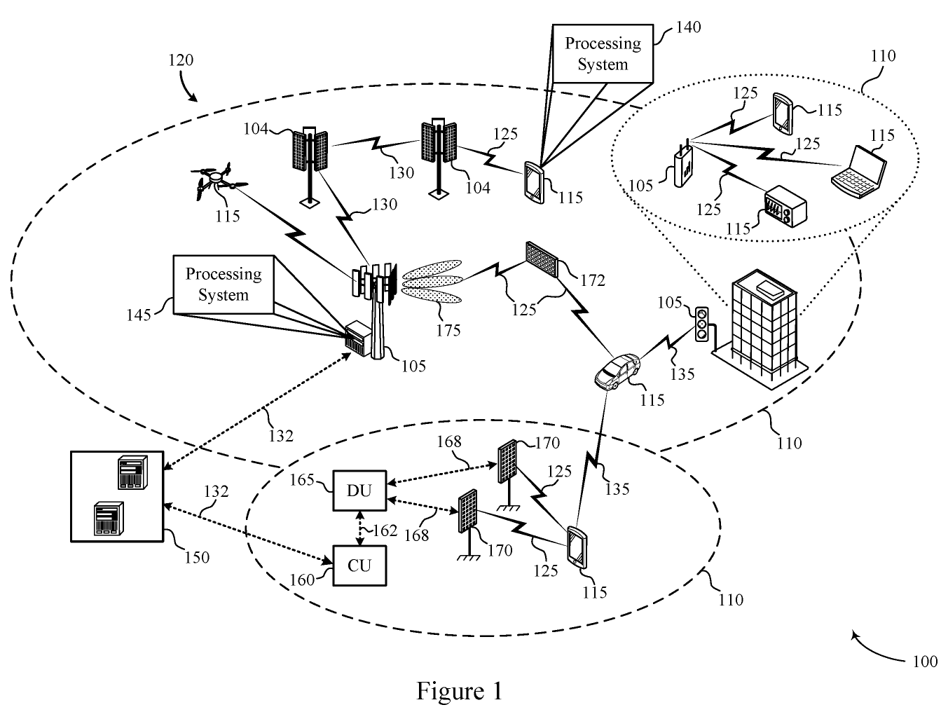

FIG. 1 shows an example of a wireless communication system 100. The wireless communication system 100 includes a core network 150 and a RAN 120 that support communication with one or more devices, such as UEs 115. A RAN 120 may include one or more network nodes 105 configured to support wireless communication with the UEs 115.

The wireless communication system 100 may support communication among network nodes 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network node 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network nodes 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network node 105 may support wireless communication in accordance with one or more coverage areas 110, and may be referred to as a network element, a network node, a RAN node, or network equipment, among other nomenclature. One or more of the network nodes 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network nodes 105 support communication for one or more coverage areas 110 using the same or different RATs.

In some examples, a network node 105 may be implemented in an aggregated (such as monolithic, standalone) architecture, which may utilize a protocol stack that is physically or logically integrated within one network node 105 (such as a single physical RAN node). In some other examples, a network node 105 may be implemented in a disaggregated architecture, which may utilize a protocol stack that is physically or logically distributed among multiple network nodes 105, including in an integrated access and backhaul (IAB) network, an open RAN (O-RAN), or a virtualized RAN (vRAN). In a disaggregated architecture, a network node 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network nodes 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network node 105 and a UE 115 may be supported using one or more of a communication link 125 (such as a Uu interface), which may include downlink communication from a network node 105 to a UE 115, uplink communication from a UE 115 to a network node 105, or both. Direct wireless communication between UEs 115 may be supported using a communication link 135 (such as a device-to-device (D2D) communication link, a sidelink, a PC5 interface).

Communication between a network node 105 and a core network 150 may be supported using a backhaul link 132 (such as an S1, N2, N3, NG, or other interface). In some implementations, communication between network nodes 105 may be supported using a backhaul link 132 (such as an X2, Xn, or other interface) either directly (such as directly between network nodes 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network node 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network nodes 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network node 105 or a UE 115.

Beamforming, such as directional transmission or directional reception, is a signal processing technique that may be used at a transmitting device or a receiving device (such as at a network node 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425MHz and 7.125GHz), a mid-band (such as Frequency Range 3 (FR3), between 7.125GHz and 24.25GHz), or an upper frequency band (such as Frequency Range 2 (FR2), between 24.25GHz and 71GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network node 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network node 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network node 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network node 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network nodes 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network nodes 105 and UEs 115 may receive and measure transmitted reference signals to support one or more of these and other functions.

Devices of the wireless communication system 100 may be configured to support one or more aspects of the described techniques for power boost for delay critical procedures. For example, a UE 115 may include a processing system 140, and a network node 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support reduced latency and increased throughput for communication of delay-sensitive data. For example, by configuring power boosting to be used for one or more messages in a delay critical procedure, the described techniques can be used to increase a reliability of communication for the delay-sensitive data. By boosting the transmission power used to communicate such messages, the UE 115 may ensure that the messages will be received and recognized by a network node 105, which may result in a more efficient scheduling, a faster and more efficient grant allocation for the UE 115 to communicate the delay-sensitive data, an improved coordination between devices in the wireless communication system 100, and improved KPI performance leading to enhanced user experience.

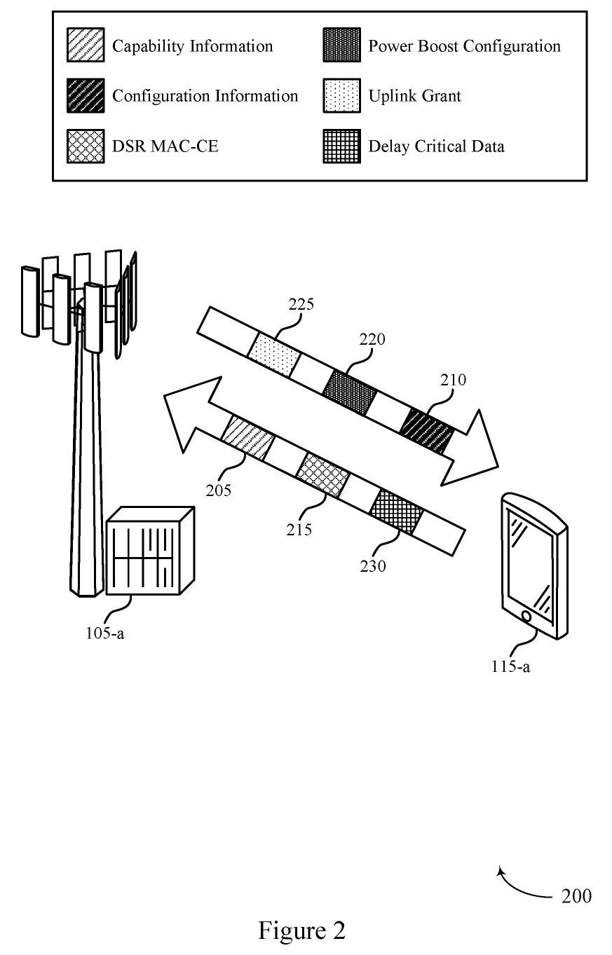

FIG. 2 shows an example of a signaling configuration 200 that supports power boost for delay critical procedures. The signaling configuration 200 may implement or be implemented by aspects of the wireless communication system 100. For example, the signaling configuration 200 may include a UE 115-a and a network node 105-a, which may be examples of corresponding devices described herein.

As part of one or more rules for XR communications, as user experience may be dependent on throughput as well as latency to give immersive user experience, various XR-specific procedures may be defined to support KPIs, such as throughput and latency. For example, one or more procedures may be introduced to group packets (e.g., protocol data units (PDUs)) which belong to one application data unit (ADU) into a PDU set and associated PDU set characteristics may be defined such as a PDU set delay budget (PSDB), a PDU set importance (PSI), a PDU set error rate (PSER), and associated sequence numbering as defined by a PDU set sequence numbering (PSSN), among other PDU set characteristics.

While the PDU set may provide the logical relation between the packets and their user experience requirements, there may be delays due to radio procedures in ensuring timely update of a buffer status to a network node 105-a and in receiving an uplink grant 225 to ensure that PDU set level KPIs are satisfied. As part of this, various procedures (e.g., delay remediation procedures) may be implemented by the UE 115-a at a MAC layer. For example, a DSR included in a DSR MAC-CE 215 may be used as a mechanism to satisfy the described KPIs.

A DSR procedure (e.g., delay remediation procedure) may introduce mechanisms for exchanging a buffer status from the UE 115-a-a to the network node 105-a, and may be triggered when the remaining time of the PDU set based on a discard timer at the UE 115-a is below the remaining time threshold configured by the network node 105-a. The delay remediation procedure may involve scheduling and sending messaging in an attempt to coordinate with the network node 105-a in order to deliver the PDU set on time. For example, the DSR MAC-CE 215 may carry the buffer status of a logical channel (LC) associated as part of an LCG to the network node 105-a to support a relatively quick and/or enhanced uplink grant from the network node 105-a, to ensure PDU set level KPIs are satisfied.

The UE 115-a-a may be configured (e.g., via configuration information 210) with a PDU level quality of service (QoS) or a PDU set level QOS, which may be based on packet data convergence protocol (PDCP) resource block (RB) characteristics and UE capability. The UE 115-a may start a PDCP discard timer associated for each PDU or PDU Set, when they arrive to a PDCP uplink queue. The UE 115-a may be configured (e.g., via configuration information 210) with a remainingTimeThreshold for each LCG by the network node 105-a, which may be based on a radio network configuration and a scheduling policy.

Whenever a remaining discard timer for any of the data (e.g., PDUs or PDU sets) from an LC which belongs to the LCG falls below the remainingTimeThreshold threshold, the UE 115-a may report the buffer status report that corresponds to any remaining delay critical data 230 (e.g., delay-sensitive data) at the UE 115-a on various radio link control (RLC) or PDCP procedures. The reporting of the buffer status report for any delay critical data 230 at the UE 115-a may be otherwise referred to herein as a DSR. In some examples, to report the buffer status report, a MAC layer of the UE 115-a may use a buffer status table, depending on the UE capability and network configuration. According to one or more MAC procedures, the DSR MAC-CE 215 may be triggered and includes buffer details for the LCs associated in the configured LCG. For example, the UE 115-a may report the buffer details to the network node 105-a to support improved grant and scheduling management.

Though sending the DSR MAC-CE 215 with the buffer status report (e.g., DSR) may provide the latest information related to delay critical data 230 for better scheduler handling, it may inform the network node 105-a only about the data volume pending with the UE 115-a. As the delay critical data 230 may already be in a delay critical mode from a timeline perspective, resources (e.g., a scheduling of resources) associated with the transmission of the delay critical data 230 may also be addressed to support further improvements.

In some examples, a logical channel priority (LCP) procedure may be introduced. As part of the LCP procedure, the network node 105-a may configure priority inheritance for a given LC during a delay critical stage, to ensure higher LCP resources are utilized to help with priority transmission of the DSR MAC-CE 215 during a MAC TB encoding. In some examples, a SR procedure may be introduced. For example, there may be no uplink grant associated with the UE 115-a, and a SR may be triggered by the UE 115-a to request the uplink grant 225. To reduce an associated SR latency, the UE 115-a may be allowed to use high priority scheduling resources which are associated with the LC for the upcoming physical uplink control channel (PUCCH) transmission that includes the SR.

The procedures described (e.g., LCP to prioritize data, SR to utilize priority resources) may reduce the latency with respect to a DSR MAC-CE 215 transmission. However, it may be beneficial to introduce additional mechanisms to improve the reliability of the DSR MAC-CE 215 or of an associated delay critical data 230 transmission.

In a wireless communications system, successful delivery of delay critical data 230 between peer entities of a link layer (e.g., between the UE 115-a and the network node 105-a) may be based on grant management to address latency and block error rate (BLER) management to reduce errors. Issues with the BLER management may directly translate into associated retransmissions resulting in increased latency and reduced effective throughput, which may reduce a realization of the XR KPIs and may cause a degraded immersive user experience. Additionally, or alternatively, the increased latency or reduced throughput due to the BLER management issues may negatively impact mission critical operations for unmanned aerial vehicles (UAVs), such as command control or waypoint updates to a UAV flight path.

In some cases (e.g., most of the time), the UE 115-a may not operate at peak uplink transmission power as many coverage cells may limit a total allowed uplink transmit power at a cell level via cell related system information (e.g., system information blocks (SIBs)) or via a dedicated configuration to ensure a reduced inter-cell interference, since transmit power may be a key metric to control interference of neighboring devices.

The network node 105-a may not know when the DSR MAC-CE 215 is triggered in the uplink (e.g., whether by MAC TB or by a DSR-triggered SR) to control the reliability by reducing the modulation and coding scheme (MCS) for increased reliability. For example, a power per bit may be controlled, but the power may not be increased based on the contents of the DSR MAC-CE 215 (e.g., whether the DSR MAC-CE 215 includes the MAC TB or the SR). However, loss of DSR MAC-CE information to the network node 105-a or loss of an associated SR to the network node 105-a may be detrimental to various procedures defined for communication of the delay critical data 230. Even with a conservative MCS (e.g., relatively low-level MCS), there may not be any power boost to the ongoing MAC TB to increase reliability, as a conservative MCS may only help to improve the redundancy bits or symbol level decoding opportunities. In some examples, a performance KPI may be a function of throughput, latency, and reliability, where reliability may indirectly impact throughput and latency.

In accordance with examples described herein, a UE 115-a may improve the reliability of delay-sensitive messaging (e.g., when a delay critical procedure is triggered) using power boosting, which may improve one or more KPIs for XR and/or other applications involving delay critical data 230. During one or more delay critical triggering procedures (e.g., delay remediation procedures), the UE 115-a may be configured to power boost various communications and/or procedures of the delay critical triggering procedure. For example, the UE 115-a may power boost a DSR MAC-CE 215 transmission. In some examples, the UE 115-a may power boost the DSR MAC-CE 215 transmission as part of an ongoing MAC TB included in the DSR MAC-CE 215, if an uplink grant 225 is already available. In some examples, the UE 115-a may power boost the DSR MAC-CE 215 transmission as part of an enhanced SR procedure initiation triggered by the DSR MAC-CE 215, if an uplink grant 225 is not yet available. Additionally, or alternatively, the UE 115-a may power boost an actual transmission of delay critical data 230 (e.g., in subsequent transmissions).

As part of power spectral efficiency and based on defined scheduling procedures, the UE 115-a may report (e.g., via capability information 205) a power head room to the network node 105-a, and the network node 105-a may perform scheduling (e.g., configure MCS) to improve a defined (e.g., maximum) data transmission within BLER guidelines. Reliability of any data transmission may improve with a higher transmit power as it reduces the number of mis-detected or not-detected symbols. For example, the power spectral efficiency may be reduced giving more energy per bit in a power boosted transmission. During the delay critical procedures, giving a power boost (e.g., transmitting at a higher transmission power level) to a MAC TB associated with the DSR MAC-CE 215 or power boost to a MAC TB carrying delay critical data 230 or power boost to a SR triggered for (e.g., by the DSR MAC-CE 215) as part of the DSR procedure may help the reliability of the ongoing transmission at the radio level. In turn, this may improve reliability, thus reducing the associated need for retransmission at a hybrid automatic repeat request (HARQ) level or a SR level and thereby reducing the latency or associated higher layer retransmissions (e.g., RLC automatic repeat request (ARQ) or application-level retransmissions).

Power boosting of the various communications and/or procedures of delay critical procedures, which may otherwise be referred to herein as power boosting of delay-sensitive messaging, may be according to capabilities and configurations signaled between the UE 115-a and the network node 105-a. In some examples, the UE 115-a may transmit capability information 205 to indicate a UE capability to support power boosting of the delay-sensitive messaging. A UE capability to support power boosting may be a mandatory or optional procedure.

The network node 105-a may transmit a power boost configuration 220 indicating one or more power boost parameters for boosting transmission power of the delay-sensitive messaging when the delay critical procedure is triggered. An amount of power boost (e.g., a transmit power) may be part of the power boost configuration 220 between the UE 115-a and the network node 105-a (and may be indicated via the power boost parameters). Additionally, or alternatively, a power boost configuration for boosting transmission power of the delay-sensitive message may be specific to a UE implementation (e.g., determined by the UE 115-a internally without input from network node 105-a).

In some examples, the amount of power boost may be indicated per LCG based on traffic mapping to LCs or may be based on PDU Set characteristics (e.g., PSER). For example, PDUs associated with a lesser PSER may be configured with more power boost than PDUs associated with a higher PSER, which may be dependent on a higher layer redundancy metric. In some other examples, the amount of power boost may be indicated per UE based on a UE power class. In some other examples, an amount of power boost may be indicated based on a service type (e.g., XR, UAV, or some other sub-classification), a PDU session, or an application (e.g., a relative criticality or importance or priority of an application). Additionally, or alternatively, an amount of power boost may be dynamically indicated through a dedicated signaling (e.g., control signaling) or a broadcast signaling (e.g., SIB) mechanism. In some examples, the amount of power boosting may be indicated in terms of a series of power boost steps (e.g., increments) or a fixed value. In some examples, the power boost configuration 220 may be updated (e.g., periodically) via dedicated signaling (e.g., control signaling) or via broadcast signaling in a semi-static manner.

In some examples, the power boost configuration (e.g., coordinated between the network node 105-a and the UE 115-a via power boost configuration 220 or UE implementation specific) may be translated in a calculation of a power headroom MAC-CE during the delay critical procedures to ensure the network node 105-a takes into consideration the power boost configuration during scheduling grants (e.g., the uplink grant 225) to the UE 115-a. For example, the UE 115-a may modify an indicated power headroom to be less than an actual power headroom of the UE 115-a in accordance with an amount of power boosting to be applied to delay-sensitive messaging (e.g., some power headroom is held in reserve for the power boosting). In this way, the UE may ensure that transmission power of the delay-sensitive messaging after power boosting is applied does not exceed UE power headroom capabilities.

In some examples, the power boost configuration 220 may indicate a transmit power boost range to the UE 115-a, and the UE 115-a may determine a specific transmit power level within the transmit power boost range using an AI-native machine learning model. For example, the network node 105-a may communicate the transmit power boost range to the UE 115-a as part of the power boost configuration 220 (or using additional signaling, such as RRC or DCI signaling), and the UE 115-a may input one or more AI-native parameters corresponding to the delay-sensitive messaging into the AI-native machine learning model. the one or more AI-native parameters may include The UE 115-a may obtain a model inference from the AI-native machine learning model, where the model inference includes at least the transmit power level selected from within the transmit power boost range. In this way, the network node 105-a may define the bounds of allowable power boosting, while the UE 115-a may use AI-native logic to select the specific transmit power level within those bounds that is suited to current conditions.

In some examples, the AI-native machine learning model may be internal to a modem of the UE 115-a. Additionally, or alternatively, the AI-native machine learning model may be coordinated with a service in an application processor of the UE 115-a, coordinated with a network-based AI-native machine learning model hosted by the network node 105-a, or any combination thereof. For example, the model inference may be based on information obtained locally from the modem of the UE 115-a, information obtained from a service in the application processor of the UE 115-a, information coordinated between the UE 115-a and the network node 105-a via a network-based AI-native machine learning model, or any combination of such information sources. In some examples, the network node 105-a may provide or coordinate with the UE 115-a to configure the AI-native machine learning model such that the model inference selects a transmit power level within the transmit power boost range that is suited to the current communication conditions.

In some examples, the one or more AI-native parameters that are input into the AI-native machine learning model may be based on a packet block error rate (BLER) of the delay-sensitive messaging, a packet error rate (PER) of the delay-sensitive messaging, or both. For example, the packet BLER or the packet PER may be observed at the UE 115-a, reported by the network node 105-a to the UE 115-a, or both, and may serve as inputs to the AI-native machine learning model to inform the model inference. In some examples, a relatively higher packet BLER or packet PER may result in a model inference that selects a relatively higher transmit power level within the transmit power boost range, while a relatively lower packet BLER or packet PER may result in a model inference that selects a relatively lower transmit power level within the transmit power boost range. In this way, the AI-native machine learning model may dynamically adapt the selected transmit power level based on observed or reported error conditions associated with the delay-sensitive messaging.

In some examples, the one or more AI-native parameters input into the AI-native machine learning model may additionally or alternatively include channel quality information associated with the UE 115-a, such as a channel quality indicator (CQI), a reference signal received power (RSRP), a reference signal received quality (RSRQ), or a signal-to-interference-plus-noise ratio (SINR). For example, a relatively lower channel quality measurement may result in a model inference that selects a relatively higher transmit power level within the transmit power boost range, while a relatively higher channel quality measurement may result in a model inference that selects a relatively lower transmit power level within the transmit power boost range. In some examples, the one or more AI-native parameters may include buffer occupancy information associated with the delay-sensitive data, such as a current buffer size, a rate of buffer fill, or a remaining buffer capacity of the UE 115-a. For example, a relatively larger buffer occupancy or a relatively faster rate of buffer fill may result in a model inference that selects a relatively higher transmit power level within the transmit power boost range, to help ensure timely delivery of the delay-sensitive data. In some examples, the one or more AI-native parameters may include timing information associated with the delay-sensitive data, such as a remaining time on a discard timer associated with a PDU or PDU set, a remaining time relative to a PDU set delay budget (PSDB), or both. For example, a relatively shorter remaining time on the discard timer or relative to the PSDB may result in a model inference that selects a relatively higher transmit power level within the transmit power boost range, to help ensure that the delay-sensitive data is delivered before the discard timer expires.

In some examples, the one or more AI-native parameters may include historical transmission performance data associated with the UE 115-a or the delay-sensitive messaging, such as a historical HARQ retransmission rate, a historical SR success rate, or a historical uplink grant allocation latency. For example, a relatively higher historical HARQ retransmission rate or a relatively higher historical SR failure rate may result in a model inference that selects a relatively higher transmit power level within the transmit power boost range, to help improve the reliability of the current transmission. In some examples, the one or more AI-native parameters may include mobility-related information associated with the UE 115-a, such as a current velocity of the UE 115-a, a rate of change of channel conditions, or a handover history of the UE 115-a. For example, a UE 115-a that is experiencing relatively rapid changes in channel conditions or a relatively high velocity may benefit from a model inference that selects a relatively higher transmit power level within the transmit power boost range, to help maintain reliable communication during periods of channel variability. In some examples, the one or more AI-native parameters may include application-layer information associated with the delay-sensitive data, such as a PDU set importance (PSI), a PDU set error rate (PSER), or a PDU set sequence number (PSSN) associated with the delay-sensitive data. For example, a PDU set associated with a relatively higher PSI or a relatively lower PSER may result in a model inference that selects a relatively higher transmit power level within the transmit power boost range, to help ensure that higher-importance or lower-error-tolerance data is delivered reliably.

In some examples, the one or more AI-native parameters may include power headroom information associated with the UE 115-a, such as a current power headroom report (PHR) value or a remaining available transmit power of the UE 115-a. For example, the AI-native machine learning model may use the power headroom information to ensure that the selected transmit power level within the transmit power boost range does not exceed the available transmit power of the UE 115-a, while still selecting a transmit power level that is suited to current communication conditions.

Thus, in accordance with these and other examples, improving the reliability of delay-sensitive messaging through power boosting may improve delay critical data indications, grant management, and successful delivery of delay critical data 230 to a peer entity (e.g., network node 105-a) to improve KPIs. For example, the UE 115-a and/or the network node 105-a may consider delay critical data triggered procedures as input to power boosting decisions, to improve reliability and reduce latency as output. With delay critical data, latency and reliability metrics may be key contributors to satisfy PDU set level characteristics and KPIs (e.g., to promote an immersive user experience for XR, to improve performance of latency specific commands for UAV flight path, among other potential applications). Thus, using power boost techniques described herein during DSR procedures may improve reliability of uplink transmissions, enhance user experience, reduce latency, and increase spectral efficiency, among other advantages.

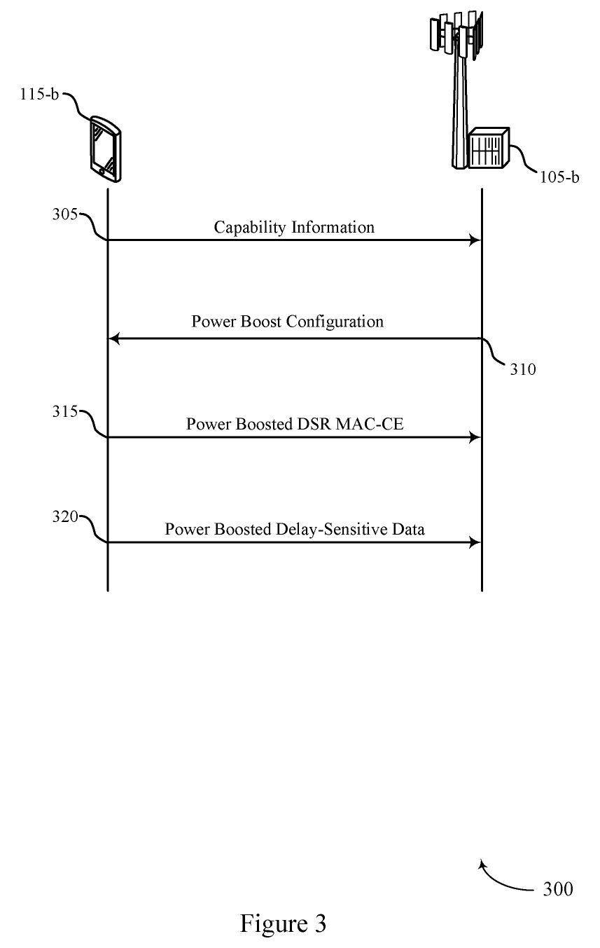

FIG. 3 shows an example of a process flow 300 that supports power boost for delay critical procedures. The process flow 300 may implement or be implemented by aspects of the wireless communication system 100 or the signaling configuration 200. For example, the process flow 300 may include a UE 115-b and a network node 105-b, which may be examples of corresponding devices described herein. In the following description of the process flow 300, the operations between the UE 115-b and the network node 105-b may be performed in a different order than the example shown, or the operations between the UE 115-b and the network node 105-b may be performed in different orders or at different times. For example, operations illustrated as being performed at or by the UE 115-b may be additionally or alternatively performed by the network node 105-b, or vice versa. Some operations may also be omitted from the process flow 300, and other operations may be added to the process flow 300.

At 305, the UE 115-b may communicate (e.g., transmit) capability information indicating a capability of the UE 115-b to support transmission power boosting of delay-sensitive messaging. The capability information may include a power headroom capability of the UE 115-b, which may be modified relative to an actual power headroom capability of the UE 115-b (e.g., to reserve a subset of the power headroom for power boosting).

At 310, the UE 115-b may communicate (e.g., receive) an indication of a power boost configuration indicating one or more power boost parameters for boosting transmission power of delay-sensitive messaging when a delay remediation procedure is triggered. The delay remediation procedure may be triggered based on a remaining amount of time for communication of delay-sensitive data (e.g., based on a discard timer for the data). For example, the delay remediation procedure may be triggered when the remaining amount of time for the communication of the delay-sensitive data satisfies a threshold (e.g., remainingTimeThreshold). The delay-sensitive messaging to which the power boost parameters are applicable may include a MAC-CE transmission that includes a DSR in its MAC TB, a MAC-CE transmission that triggers a SR to request an uplink grant, or a transmission of the delay-sensitive data itself, or any combination thereof. The indication of the power boost configuration may be via control signaling (e.g., RRC, MAC-CE, DCI), broadcast signaling (e.g., SIB), or any combination thereof.

The one or more power boost parameters may include at least a respective power boost parameter (e.g., an amount of power boosting, a defined transmit power) for each LCG of a set of LCGs, a respective power boost parameter for each UE power class of a set of UE power classes, a respective power boost parameter for each service type of a set of service types, or a combination thereof. For example, the delay-sensitive data may be of a first LCG, and a first power boost parameter may indicate a first transmit power applicable to data of the first LCG. A second power boost parameter may indicate a second transmit power applicable to delay-sensitive data of a second LCG, a third power boost parameter may indicate a third transmit power applicable to delay-sensitive data of a third LCG, and so on. In some examples, the power boost parameter corresponding to a given LCG may be based on traffic mapping to a LC or may be based on PDU set characteristics (e.g., PSDB, PSI, PSER, PSSN).

For example, the UE 115-b may be of a first UE power class (e.g., device power class), and a first power boost parameter may indicate a first transmit power for delay-sensitive messaging applicable to UEs belonging to the first UE power class. A second power boost parameter may indicate a second transmit power for delay-sensitive messaging applicable to UEs belonging to a second UE power class, a third power boost parameter may indicate a third transmit power for delay-sensitive messaging applicable to UEs belonging to a third UE power class, and so on.

For example, the delay-sensitive data may be of a first service type, and a first power boost parameter may indicate a first transmit power applicable to data of the first service type (e.g., XR PDUs or PDU sets). A second power boost parameter may indicate a second transmit power applicable to delay-sensitive data of a second service type (e.g., UAV commands), a third power boost parameter may indicate a third transmit power applicable to delay-sensitive data of a third service type (e.g., other service type such as sub-classification or KPI), and so on. Additionally, or alternatively, the power boost parameters may be based on a PDU session associated with the delay-sensitive data or a criticality (e.g., priority or importance) of an application associated with the delay-sensitive data.

The UE 115-b may communicate (e.g., transmit) a first message based on (e.g., in response to) the delay remediation procedure being triggered, and the first message may be transmitted with a transmit power level that is boosted in accordance with the one or more power boost parameters. The power boost parameters may indicate a fixed transmit power boosting value or one or more transmit power boosting increments.

In some examples, the UE 115-b may communicate (e.g., receive), with the network node 105-b, an indication of a transmit power boost range that is based on the one or more power boost parameters. The UE 115-b may input one or more AI-native parameters corresponding to the delay sensitive messaging into an AI-native machine learning model, and may obtain a model inference from the AI-native machine learning model which includes a transmit power level selected from the transmit power boost range. In some examples, the model inference may be based on information obtained from a modem of the UE 115-b, a service in an application processor, the AI-native machine learning model hosted by the UE 115-b, a network-based AI-native machine learning model hosted by the networknode 105-b, or any combination thereof. In some examples, the one or more AI-native parameters may be based in part on a packet BLER of the delay-sensitive messaging, a PER of the delay-sensitive messaging, or both.

For example, at 315, the UE 115-b may communicate (e.g., transmit), with the transmit power level that is based on the one or more power boost parameters, a DSR MAC-CE. The DSR MAC-CE may be a MAC-CE which is associated with providing a DSR (e.g., including buffer status reports) corresponding to the delay-sensitive data, and which may also be used in accordance with techniques described herein to trigger an SR. In one example, the first message may include a MAC-CE that indicates (e.g., includes or triggers) an SR that requests an uplink grant for transmission of the delay-sensitive data. In another example, the first message may include a MAC TB that indicates or includes the DSR.

Additionally, or alternatively, at 320, the UE 115-b may communicate (e.g., transmit), with the transmit power level that is based on the one or more power boost parameters, a TB (e.g., a MAC TB) that includes the delay-sensitive data.

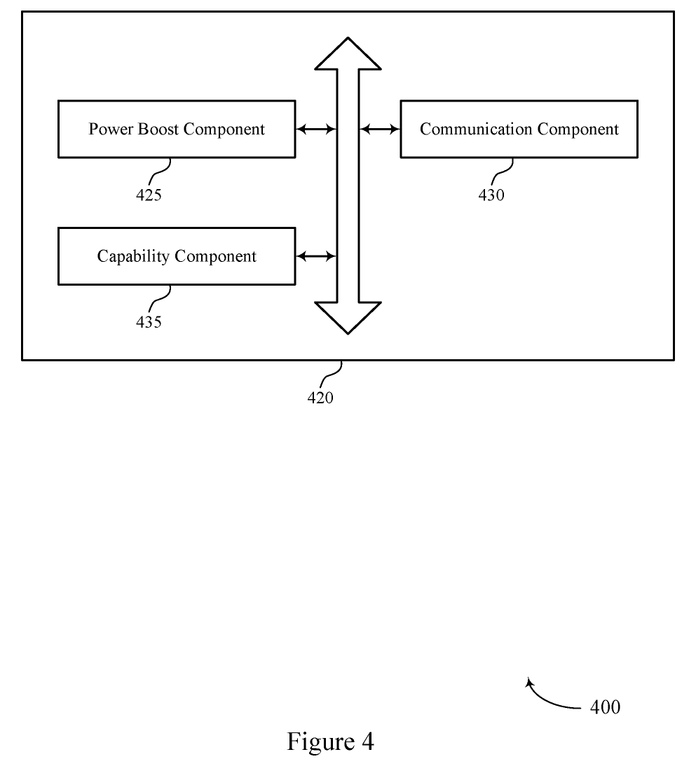

FIG. 4 shows an example 400 of a processing system 420 that supports power boost for delay critical procedures. A processing system 420 may be an example of a processing system 140 (such as of a UE 115 or a network node 105) and may include a power boost component 425, a communication component 430, a capability component 435, or any combination thereof. A processing system 420, or various component thereof, may be an example of means for performing (such as a means for causing a UE 115 or the network node 105 to perform) various techniques described herein.

The power boost component 425 may be configured to cause a wireless device (such as a UE 115 or a network node 105) to communicate (e.g., transmit, receive) an indication of a power boost configuration indicating one or more power boost parameters for boosting transmission power of delay-sensitive messaging when a delay remediation procedure is triggered, where the delay remediation procedure is triggered based on a remaining amount of time for communication of delay-sensitive data. The communication component 430 may be configured to cause the UE 115 to transmit, with a transmit power level that is boosted in accordance with the one or more power boost parameters, a first message based on the delay remediation procedure being triggered.

In some examples, to support transmitting the first message, the communication component 430 may be configured to cause the wireless device (such as the UE 115 or the network node 105) to communicate, in accordance with the transmit power level that is based on the one or more power boost parameters, the first message including a MAC-CE that provides a DSR corresponding to the delay-sensitive data.

In some examples, the MAC-CE includes a SR that requests an uplink grant for transmission of the delay-sensitive data.

In some examples, the MAC-CE includes a TB indicating the DSR.

In some examples, to support communicating the first message, the communication component 430 may be configured to cause the wireless device to communicate, in accordance with the transmit power level that is based on the one or more power boost parameters, a TB including the delay-sensitive data.

In some examples, the communication component 430 may be configured to cause the wireless device to communicate an indication of a transmit power boost range based at least in part on the one or more power boost parameters, input, into an AI-native machine learning model, one or more AI-native parameters corresponding to the delay-sensitive messaging, and obtain a model inference from the AI-native machine learning model, the model inference comprising at least the transmit power level selected from the transmit power boost range. In some examples, the model inference may be based on information obtained from a modem of the wireless device, a service in an application processor, a UE-based AI-native machine learning model, a network-based AI-native machine learning model, or any combination thereof. In some examples, the one or more AI-native parameters are based in part on a packet BLER of the delay-sensitive messaging, a PER of the delay-sensitive messaging, or both.

In some examples, the one or more power boost parameters includes a first power boost parameter for a first logical channel group. In some examples, the transmit power level used to transmit the first message is in accordance with the first power boost parameter for the first logical channel group.

In some examples, the one or more power boost parameters includes a first power boost parameter for a first device power class of a set of multiple device power classes. In some examples, the transmit power level used to transmit the first message is in accordance with the first power boost parameter for the first device power class.

In some examples, the one or more power boost parameters includes a first power boost parameter for a first service type. In some examples, the transmit power level used to communicate the first message is in accordance with the first power boost parameter for the first service type.

In some examples, the capability component 435 may be configured to cause the wireless device to communicate (e.g., transmit, receive) capability information indicating a capability of the wireless device (or another wireless device) to support transmission power boosting of the delay-sensitive messaging.

In some examples, the one or more power boost parameters indicate a fixed transmit power boosting value or one or more transmit power boosting increments.

In some examples, the indication of the power boost configuration is via control signaling, broadcast signaling, or both.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for improved communication reliability, reduced latency, more efficient utilization of communication resources, and improved coordination between devices.

In some cases, the power boost component 425, the communication component 430, and the capability component 435 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the power boost component 425, the communication component 430, and the capability component 435 discussed herein.

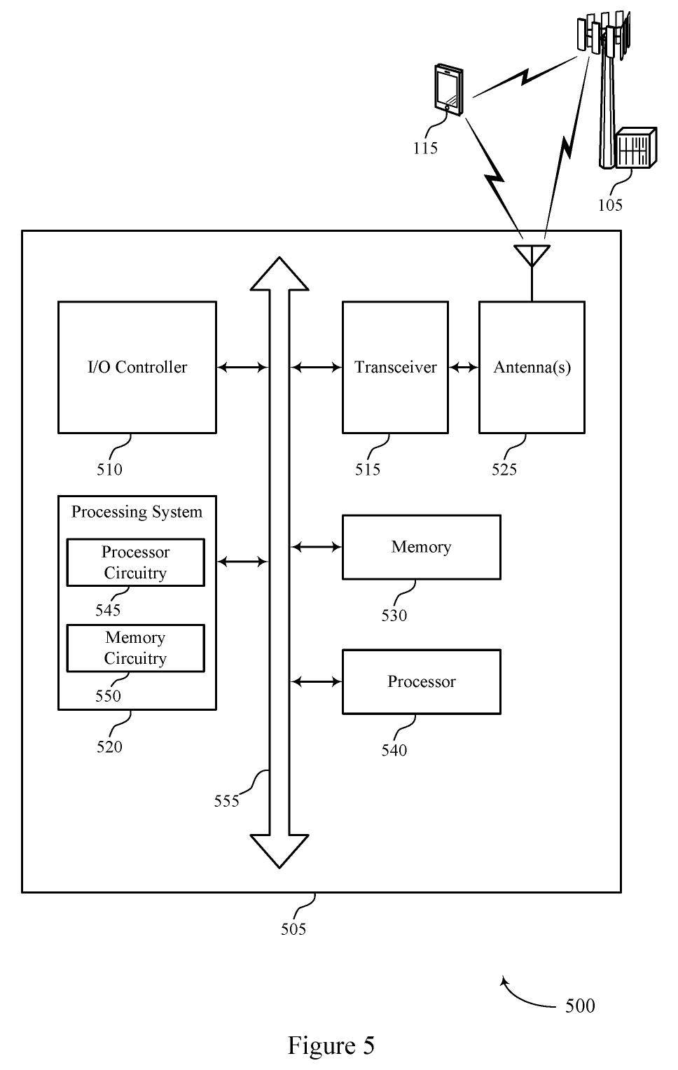

FIG. 5 shows an example of a system 500 including a device 505 that supports power boost for delay critical procedures. The device 505 may be an example of or include components of UE 115 or a network node 105. The device 505 may communicate (such as wirelessly) with one or more other devices (such as network nodes 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) with a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support power boost for delay critical procedures. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, reduced latency, more efficient utilization of communication resources, and improved coordination between devices.

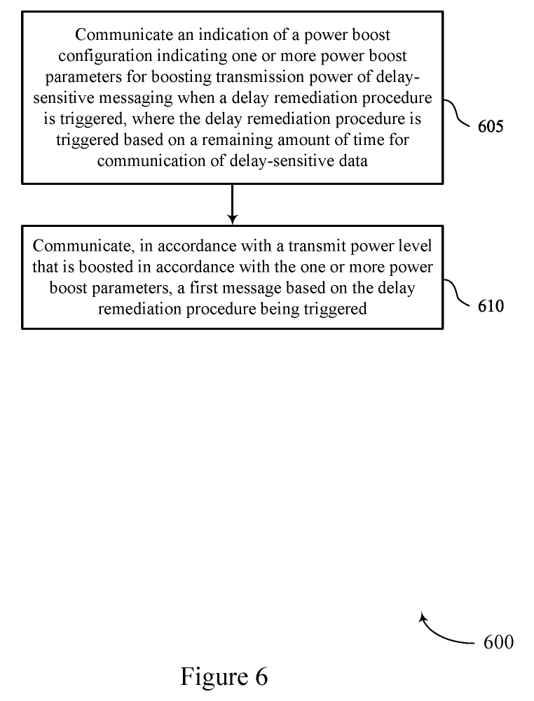

FIG. 6 shows an example of a method 600 that supports power boost for delay critical procedures. Operations of the method 600 may be performed by a wireless device (such as a UE 115 described herein, a network node 105 described herein) or its components (such as using a processing system configured to cause the wireless device to perform one or more of the operations) as described herein.

At 605, the method may include communicating (e.g., transmitting, receiving) an indication of a power boost configuration indicating one or more power boost parameters for boosting transmission power of delay-sensitive messaging when a delay remediation procedure is triggered, where the delay remediation procedure is triggered based on a remaining amount of time for communication of delay-sensitive data. In some examples, aspects of the operations of 605 may be performed by a power boost component 425.

At 610, the method may include communicating (e.g., transmitting, receiving), in accordance with a transmit power level that is boosted in accordance with the one or more power boost parameters, a first message based on the delay remediation procedure being triggered. In some examples, aspects of the operations of 610 may be performed by a communication component 430.

Implementation examples are described in the following numbered clauses:

Aspect 1: A method for wireless communications by a wireless device, comprising: communicating an indication of a power boost configuration indicating one or more power boost parameters for boosting transmission power of delay-sensitive messaging when a delay remediation procedure is triggered, wherein the delay remediation procedure is triggered based at least in part on a remaining amount of time for communication of delay-sensitive data; and communicating, in accordance with a transmit power level that is boosted in accordance with the one or more power boost parameters, a first message based at least in part on the delay remediation procedure being triggered.

Aspect 2: The method of aspect 1, further comprising: communicating an indication of a transmit power boost range based at least in part on the one or more power boost parameters; inputting, into an artificial intelligence (AI)-native machine learning model, one or more AI-native parameters corresponding to the delay-sensitive messaging; and obtaining a model inference from the AI-native machine learning model, the model inference comprising at least the transmit power level selected from the transmit power boost range.

Aspect 3: The method of aspect 2, wherein the model inference is based at least in part on information obtained from a modem of the wireless device, a service in an application processor, a user equipment (UE)-based AI-native machine learning model, a network-based AI-native machine learning model, or any combination thereof.

Aspect 4: The method of aspect 2, wherein the one or more AI-native parameters are based in part on a packet block error rate (BLER) of the delay-sensitive messaging, a packet error rate (PER) of the delay-sensitive messaging, or both.

Aspect 5: The method of aspect 1, wherein communicating the first message comprises: communicating, with the transmit power level that is based at least in part on the one or more power boost parameters, the first message comprising a MAC-CE that provides a DSR corresponding to the delay-sensitive data.

Aspect 6: The method of aspect 5, wherein the MAC-CE comprises a SR that requests an uplink grant for transmission of the delay-sensitive data.

Aspect 7: The method of any of aspects 5 through 6, wherein the MAC-CE comprises a TB indicating the DSR.

Aspect 8: The method of any of aspects 1 through 7, wherein communicating the first message comprises: communicating, in accordance with the transmit power level that is based at least in part on the one or more power boost parameters, a TB comprising the delay-sensitive data.

Aspect 9: The method of any of aspects 1 through 8, wherein the one or more power boost parameters comprises a first power boost parameter for a first logical channel group, the transmit power level used to communicate the first message is in accordance with the first power boost parameter for the first logical channel group.

Aspect 10: The method of any of aspects 1 through 9, wherein the one or more power boost parameters comprises a first power boost parameter for a first device power class of a plurality of power classes, the transmit power level used to transmit the first message is in accordance with the first power boost parameter for the first device power class.

Aspect 11: The method of any of aspects 1 through 10, wherein the one or more power boost parameters comprises a first power boost parameter for a first service type, the transmit power level used to transmit the first message is in accordance with the first power boost parameter for the first service type.

Aspect 12: The method of any of aspects 1 through 11, further comprising: communicating capability information indicating a capability of the wireless device to support transmission power boosting of the delay-sensitive messaging.

Aspect 13: The method of any of aspects 1 through 12, wherein the one or more power boost parameters indicate a fixed transmit power boosting value or one or more transmit power boosting increments.

Aspect 14: The method of any of aspects 1 through 13, wherein the indication of the power boost configuration is via control signaling, broadcast signaling, or both.

Aspect 15: A wireless device for wireless communications, comprising a processing system that includes processor circuitry and memory circuitry that stores code, the processing system configured to cause the wireless device to perform a method of any of aspects 1 through 14.

Aspect 16: A wireless device for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
a processing system that includes processor circuitry and memory circuitry that stores code, the processing system configured to cause the wireless device to:
communicate an indication of a power boost configuration indicating one or more power boost parameters for boosting transmission power of delay-sensitive messaging when a delay remediation procedure is triggered, wherein the delay remediation procedure is triggered based at least in part on a remaining amount of time for communication of delay-sensitive data; and
communicate, in accordance with a transmit power level that is boosted in accordance with the one or more power boost parameters, a first message based at least in part on the delay remediation procedure being triggered.

2. The wireless device of claim 1, wherein the processing system is further configured to cause the wireless device to:
communicate an indication of a transmit power boost range based at least in part on the one or more power boost parameters;
input, into an artificial intelligence (AI)-native machine learning model, one or more AI-native parameters corresponding to the delay-sensitive messaging; and
obtain a model inference from the AI-native machine learning model, the model inference comprising at least the transmit power level selected from the transmit power boost range.

3. The wireless device of claim 2, wherein the model inference is based at least in part on information obtained from a modem of the wireless device, a service in an application processor, a user equipment (UE)-based AI-native machine learning model, a network-based AI-native machine learning model, or any combination thereof.

4. The wireless device of claim 2, wherein the one or more AI-native parameters are based in part on a packet block error rate (BLER) of the delay-sensitive messaging, a packet error rate (PER) of the delay-sensitive messaging, or both.

5. The wireless device of claim 1, wherein, to communicate the first message, the processing system is configured to cause the wireless device to:
communicate, in accordance with the transmit power level that is based at least in part on the one or more power boost parameters, the first message comprising a medium access control-control element that provides a delay status report corresponding to the delay-sensitive data.

6. The wireless device of claim 5, wherein the medium access control-control element comprises a scheduling request that requests an uplink grant for transmission of the delay-sensitive data.

7. The wireless device of claim 5, wherein the medium access control-control element comprises a transport block indicating the delay status report.

8. The wireless device of claim 1, wherein, to communicate the first message, the processing system is configured to cause the wireless device to:
communicate, in accordance with the transmit power level that is based at least in part on the one or more power boost parameters, a transport block comprising the delay-sensitive data.

9. The wireless device of claim 1, wherein the one or more power boost parameters comprises a first power boost parameter for a first logical channel group, and wherein the transmit power level used to transmit the first message is in accordance with the first power boost parameter for the first logical channel group.

10. The wireless device of claim 1, wherein the one or more power boost parameters comprises a first power boost parameter for a first device power class of a plurality of device power classes, and wherein the transmit power level used to transmit the first message is in accordance with the first power boost parameter for the first device power class.

11. The wireless device of claim 1, wherein the one or more power boost parameters comprises a first power boost parameter for a first service type, and wherein the transmit power level used to transmit the first message is in accordance with the first power boost parameter for the first service type.

12. The wireless device of claim 1, wherein the processing system is further configured to cause the wireless device to:
communicate capability information indicating a capability of the wireless device to support transmission power boosting of the delay-sensitive messaging.

13. The wireless device of claim 1, wherein the one or more power boost parameters indicate a fixed transmit power boosting value or one or more transmit power boosting increments.

14. The wireless device of claim 1, wherein the indication of the power boost configuration is via control signaling, broadcast signaling, or both.

15. A method for wireless communications by a wireless device, comprising:
communicating an indication of a power boost configuration indicating one or more power boost parameters for boosting transmission power of delay-sensitive messaging when a delay remediation procedure is triggered, wherein the delay remediation procedure is triggered based at least in part on a remaining amount of time for communication of delay-sensitive data; and
communicating, in accordance with a transmit power level that is boosted in accordance with the one or more power boost parameters, a first message based at least in part on the delay remediation procedure being triggered.

16. The method of claim 15, further comprising:
communicating an indication of a transmit power boost range based at least in part on the one or more power boost parameters;
inputting, into an artificial intelligence (AI)-native machine learning model, one or more AI-native parameters corresponding to the delay-sensitive messaging; and
obtaining a model inference from the AI-native machine learning model, the model inference comprising at least the transmit power level selected from the transmit power boost range.

17. The method of claim 16, wherein the model inference is based at least in part on information obtained from a modem of the wireless device, a service in an application processor, a user equipment (UE)-based AI-native machine learning model, a network-based AI-native machine learning model, or any combination thereof.

18. The method of claim 16, wherein the one or more AI-native parameters are based in part on a packet block error rate (BLER) of the delay-sensitive messaging, a packet error rate (PER) of the delay-sensitive messaging, or both.

19. The method of claim 15, wherein communicating the first message comprises:
communicating, in accordance with the transmit power level that is based at least in part on the one or more power boost parameters, the first message comprising a medium access control control element that provides a delay status report corresponding to the delay-sensitive data.

20. A non-transitory computer-readable medium storing code for wireless communications, the code comprising instructions executable by one or more processors to:
communicate an indication of a power boost configuration indicating one or more power boost parameters for boosting transmission power of delay-sensitive messaging when a delay remediation procedure is triggered, wherein the delay remediation procedure is triggered based at least in part on a remaining amount of time for communication of delay-sensitive data; and
communicate, in accordance with a transmit power level that is boosted in accordance with the one or more power boost parameters, a first message based at least in part on the delay remediation procedure being triggered.
